(19) United States
(12) Patent Application Publication
(10) Pub. No.: US 2017/0167463 A1
(43) Pub. Date: Jun. 15, 2017

(54) Hand-Guided Power Tool

(71) Applicant: Andreas Stihl AG & Co. KG, Waiblingen (DE)

(72) Inventors: Günter Wolf, Oppenweiler (DE); Wolfgang Weissert, Winnenden (DE)

(21) Appl. No.: 15/376,970

(22) Filed: Dec. 13, 2016

(30) Foreign Application Priority Data
Dec. 15, 2015 (EP) 15 003 564.0

(51) Int. Cl. F02P 5/153; F02B 63/02; F02P 15/00; B23D 57/02; B27B 17/08

(52) U.S. Cl. CPC F02P 5/153; B23D 57/023; B27B 17/08; F02P 15/001; F02B 63/02

(57) ABSTRACT

A hand-guided power tool is provided with an internal combustion engine that has a cylinder and a piston disposed in the cylinder and delimiting together with the cylinder a combustion chamber. A connecting rod connects the piston and the crankshaft. The piston in operation of the internal combustion engine rotatably drives the crankshaft. An electronic control unit and an ignition device with a spark plug are provided. A support is fixedly connected to the crankshaft and a signal transducer is fixedly connected to the support. The ignition device, utilizing a signal generated by the at least one signal transducer, fires the spark plug at a timing which is predetermined by the electronic control unit. The support has a polygonal conical receptacle and the crankshaft has a corresponding polygonal conical section arranged in the polygonal conical receptacle to fixedly connect the support and the crankshaft to each other.

### BACKGROUND OF THE INVENTION

The invention relates to a hand-guided power tool and a method for its production.

U.S. Pat. No. 7,859,124 B2 discloses a hand-guided power tool comprising an internal combustion engine in which the rotor of a generator is connected fixedly to the fan wheel of the internal combustion engine. A magnet ring with permanent magnets is provided as a rotor. The generator is used as a signal source in order to provide an ignition angle signal. It has been found that the running behavior of the internal combustion engine is not always optimal.

The invention has the object to provide a power tool of the aforementioned kind that exhibits an improved running behavior.

A further object of the invention resides in providing a method for producing a power tool.

### SUMMARY OF THE INVENTION

In accordance with the invention, the object is solved with regard to the power tool by a hand-guided power tool comprising an internal combustion engine comprising a cylinder in which a combustion chamber delimited by a piston is provided, wherein the piston in operation drives in rotation by means of a connecting rod a crankshaft about an axis of rotation of the crankshaft, wherein the power tool comprises an electronic control unit and an ignition device, wherein the ignition device comprises a spark plug, wherein a support for at least one signal transducer is connected with the crankshaft, wherein the signal transducer is fixed on the support, wherein the ignition device, by utilizing a signal generated by the signal transducer, fires the spark plug at an ignition timing predetermined by the electronic control unit, wherein the support comprises a polygonal conical receptacle, and wherein the crankshaft has a polygonal conical section that corresponds with the polygonal conical receptacle of the support and is arranged in the polygonal conical receptacle of the support.

With regard to the method, the object is solved by a method for producing the hand-guided power tool comprising an internal combustion engine comprising a cylinder in which a combustion chamber delimited by a piston is provided, wherein the piston in operation drives in rotation by means of a connecting rod a crankshaft about an axis of rotation of the crankshaft, wherein the power tool comprises an electronic control unit and an ignition device, wherein the ignition device comprises a spark plug, wherein a support for at least one signal transducer is connected with the crankshaft, wherein the signal transducer is fixed on the support, wherein the ignition device, by utilizing a signal generated by the signal transducer, fires the spark plug at an ignition timing predetermined by the electronic control unit, wherein the support comprises a polygonal conical receptacle, and wherein the crankshaft has a polygonal conical section that corresponds with the polygonal conical receptacle of the support and is arranged in the polygonal conical receptacle of the support, wherein the crankshaft comprises an alignment element and wherein the polygonal conical section of the crankshaft is ground such that the polygonal conical section is oriented in a predefined way relative to the alignment element.

In order to achieve a good running behavior of an internal combustion engine, the mixture in the combustion chamber is ignited at a predetermined timing. The ignition timing, as a function of operating parameters of the internal combustion engine, can be preset in an electronic control unit. It has been found that the actual point in time at which an ignition spark is triggered in the combustion chamber of the internal combustion engine may deviate from the theoretical ignition timing that is determined by the electronic control unit.

Usually, for connecting the crankshaft with the support a feather key connection is provided which is axially fixed by means of a cone press-fit connection. Such a feather key connection, prior to fixation by means of the cone press-fit connection, has clearance in circumferential direction. It has been found that because of this the position of the signal transducer relative to the position of the piston may vary from engine to engine within the range of tolerances of the feather key connection. The point in time at which actually an ignition spark is triggered can therefore deviate from the ignition timing that has been determined by the electronic control unit. It has been found that this deviation may cause unfavorable running behavior of an internal combustion engine.

In the power tool according to the invention, it is provided that the support comprises a polygonal conical receptacle and that the crankshaft comprises a polygonal conical section which corresponds with or matches the polygonal conical receptacle of the support and is arranged in the polygonal conical receptacle. When mounting the support on the crankshaft, the polygonal conical section of the crankshaft is introduced into the polygonal conical receptacle of the support. In this way, a precise relative positioning of the support and of the crankshaft relative to each other is achieved. In this way, a precise positioning of the signal transducer, which is fixed on the support, relative to the rotational position of the crankshaft and thus relative to the position of the piston is achieved. The actual ignition of the mixture in the combustion chamber can therefore be carried out comparatively exactly at the desired ignition timing determined by the electronic control unit. In this way, a good running behavior of the internal combustion engine can be achieved.

The polygonal connection of crankshaft and support effects a good torque transmission from the crankshaft onto the support. Since the shape of the polygonal conical section of the crankshaft corresponds with (matches) the shape of the polygonal conical receptacle, most of the circumferential surface of the polygonal conical section of the crankshaft can be utilized for torque transmission. The axial position of the polygon connection can therefore be shorter than in case of feather key connections. Since most of the circumferential surface of the polygonal conical section of the crankshaft can be utilized for torque transmission, a transmission of the torque from the crankshaft onto the support is realized with uniform stress distribution. A minimal surface pressure between support and crankshaft results. This increases the strength and the stability of the polygon connection; in comparison to the prior art, the risk of damage, in particular of the support, is reduced due to the significantly reduced stress concentration (notch effect).

In comparison to the prior art, a reduced pretension force for fixation of the support on the crankshaft is required. In the prior art, the torque transmission is realized to a high degree by the friction force that is created by pressing the support onto the crankshaft. Due to the polygonal conical connection, most of the circumferential surface of the polygonal conical section of the crankshaft can be utilized for torque transmission and a reduced pretension force for fixation of the support on the crankshaft is required. In comparison to the prior art, the feather key is eliminated so that the number of components that must be mounted is reduced.

A polygonal cone is a cone whose cross section deviates from the shape of a circle. Advantageously, the cross section of the polygonal conical section deviates from the shape of a circle. Advantageously, the polygonal conical section has at least two lateral surfaces which are flattened relative to a circular cone shape. The circumferential surface of the polygonal cone is therefore formed of a plurality of lateral surfaces. In an advantageous configuration, the polygonal conical section has two to nine flattened lateral surfaces. It is particularly advantageous when three flattened lateral surfaces are provided. At least one lateral surface and in particular all lateral surfaces are at least partially rounded in an advantageous configuration. In a preferred embodiment, at least one lateral surface and in particular all lateral surfaces are embodied completely with a rounded configuration. However, it can also be provided that at least one and in particular all lateral surfaces are embodied to be at least partially flat. In a preferred embodiment, at least one lateral surface and in particular all lateral surfaces comprise, at least in a section thereof, a convex curvature. Preferably, at least one lateral surface and in particular all lateral surfaces are completely convex. A concave curvature of at least one section of one or a plurality of lateral surfaces, in particular all lateral surfaces, can be advantageous also. In case of a concave curvature of at least one lateral surface, the angle between the concave lateral surface and the neighboring lateral surface is less than 180°.

Preferably, the cross sections of the polygonal conical sections in each section plane perpendicular to the axis of rotation of the crankshaft are similar relative to each other. The cross sections can be transferred into each other by geometric similarity projection, i.e., by central stretching.

Advantageously, the polygonal conical section of the crankshaft has at least two first sidelines on which points are positioned which, in section planes perpendicular to the axis of rotation, have the greatest spacing relative to the axis of rotation. In an advantageous configuration, at least one first sideline and in particular all first sidelines are located in the area of a curvature. The polygonal conical section is therefore formed with rounded corners. The first sidelines that contain the points with greatest spacing relative to the axis of rotation in the respective cross section are advantageously not positioned on a corner but on a rounded portion. The polygonal conical receptacle is formed accordingly. Since the areas with the greatest spacing to the axis of rotation each are positioned on a curvature, the notch effect in the polygonal conical receptacle when transmitting torque is reduced. Advantageously, in circumferential direction, each first sideline is adjoined by a curvature at least at one side. This is in particular advantageous when the polygonal conical section comprises at least one flat area. Advantageously, two flat areas that adjoin each other in circumferential direction have between them a curved area. Preferably, at least one flat area is arranged at a first sideline. Accordingly, stress peaks at the first sidelines can be reduced. The at least one flat area in this context is advantageously very small and extends in particular across less than 1 mm.

Preferably, the polygonal conical section in each cross section is of a curved configuration across the entire circumference, in particular is convexly curved. The polygonal conical section has advantageously a continuous cross-sectional course without sharp edges.

The polygonal conical section of the crankshaft comprises advantageously at least two second sidelines on which points are located which, in section planes perpendicular to the axis of rotation, have the smallest spacing relative to the axis of rotation. Advantageously, at least one second sideline and in particular all second sidelines are positioned within the area of a curvature. Advantageously, the polygonal conical section is formed with a uniform cross section so that the first sidelines and the second sidelines alternate in circumferential direction. However, it can also be provided that two first sidelines are provided between which no second sideline is provided but between which an area is extending whose spacing to the axis of rotation is between the smallest spacing and the greatest spacing relative to the axis of rotation.

In preferred configuration, each lateral surface extends from a first sideline to a neighboring first sideline in circumferential direction. Advantageously, each one of the lateral surfaces contains a second sideline. In preferred configuration, the length of all lateral surfaces measured in angular degrees about the axis of rotation is identical. In a preferred configuration, the shape of all lateral surfaces is identical.

Advantageously, the angle between neighboring lateral surfaces is not greater than 180°. The angle between neighboring lateral surfaces in this context is measured between the circumferential centers of the lateral surfaces in circumferential direction. When the lateral surfaces at their circumferential center are curved, the angle is measured relative to the tangent at the circumferential center of the lateral surface. The angle between the neighboring lateral surfaces in this context is measured such that the angle opens in the direction toward the axis of rotation. Advantageously, the cross section of the polygonal conical receptacle does not have two lateral surfaces between which an angle that is opening relative to the axis of rotation of more than 180° is defined. The cross section of the polygonal conical section has therefore no inwardly projecting sections such as e.g. longitudinal grooves or the like.

The ratio of the number of signal transducers on the support relative to the number of lateral surfaces os advantageously an integer. Accordingly, the support can be mounted in different rotational positions on the crankshaft. The orientation of the signal transducers relative to the lateral surfaces is the same, respectively. In this context, the signal transducers are advantageously arranged at uniform angular spacings about the crankshaft.

The cross section of the polygonal conical section comprises in any section plane perpendicular to the axis of rotation an outer circle and an inner circle. The ratio of the radius of the outer circle to the radius of the inner circle is advantageously from 1.05 to 1.2. In a particularly advantageous configuration, the ratio of the radius of the outer circle to the radius of the inner circle is from 1.09 to 1.15. In an advantageous configuration, the center point of the outer circle of the polygonal conical section in any section plane perpendicular to the axis of rotation is located in the axis of rotation of the crankshaft. On the outer circle, all points with the greatest spacing relative to the axis of rotation are thus located. On the inner circle, all points that have the smallest spacing relative to the axis of rotation are located.

The radius of curvature of the lateral surfaces is advantageously greater than the radius of the outer circle. The radius of the cross section at the points with greatest spacing to the axis of rotation is in particular smaller than the radius of the inner circle about the cross section.

Advantageously, it is provided that a nominal position of the signal transducer is stored in the electronic control unit for a predetermined position and movement direction of the piston in the cylinder and that the actual position of the signal transducer in the predetermined position of the piston is deviating by less than 2.5° crank angle, in particular by less than 2° crank angle, from the nominal position. The actual position and the nominal position are in this context angular positions relative to the rotational position upon rotation about the axis of rotation of the crankshaft. Since the deviation between the actual position and the nominal position of the signal transducer for a predetermined position of the piston is smaller than 2.5°, a signal which is generated by the signal transducer in the predetermined position of the piston can be used in order to trigger with high precision the ignition spark at the desired ignition timing determined by the control unit. The timing of the spark triggering action can be determined by the electronic control unit or by so-called magneto ignition. In case of magneto ignition, usually the required ignition voltage for producing the ignition spark is generated by induction of the voltage in a coil by means of one or a plurality of permanent magnets. The induced voltage is intermediately stored by a capacitor. The signal which is generated by the signal transducer can then be used for triggering the ignition spark. The permanent magnet or permanent magnets are preferably embedded by casting in the circumferentially extending rim of the support.

Advantageously, it is provided that the polygonal conical section of the crankshaft comprises a circumferential surface and that the circumferential surface in a plane in which also the axis of rotation of the crankshaft is positioned is oriented at an angle of 6° to 12°, in particular 8.5° to 10°, relative to the axis of rotation. Due to the conical configuration of the polygonal conical section of the crankshaft, it is possible to press the polygonal conical receptacle of the support onto the polygonal conical section of the crankshaft and to fasten the support by means of only one fastening element on the crankshaft. When orienting the circumferential surface in a plane in which also the axis of rotation is positioned at an angle of 6° to 12° to the axis of rotation, the pressing force is distributed onto a large surface area when pressing the support onto the crankshaft. Accordingly, the force which is acting on the polygonal conical receptacle of the support upon pressing the support onto the crankshaft is small. Detaching the crankshaft from the receptacle is possible in a simple way because within the indicated angle range no self-locking action of polygonal conical receptacle of the support and polygonal conical section of the crankshaft takes place. Advantageously, the cross section of the polygonal conical section of the crankshaft decreases perpendicular to the axis of rotation of the crankshaft in the direction of the longitudinal axis of the crankshaft in a direction away from the cylinder. Expediently, the fastening element for pressing the support onto the crankshaft is a nut. By orientation of the circumferential surface at an angle of 6° to 12° relative to the axis of rotation, the force introduction into the polygon-shaped receptacle and the support is uniform.

Advantageously, it is provided that the polygonal conical section of the crankshaft comprises at least three sidelines on which points are located which, in section planes perpendicular to the axis of rotation, have the greatest spacing relative to the axis of rotation. Since the polygonal conical section comprises at least three such sidelines, the forces for transmitting the torque from the crankshaft onto the support are distributed uniformly on the circumferential surface of the polygonal conical section and on the polygonal conical receptacle. The sidelines are advantageously displaced by 120° relative to each other. Preferably, the polygonal conical section of the crankshaft comprises precisely three such sidelines. Preferably, a cross-sectional surface of the polygonal conical section perpendicular to the axis of rotation is a three-sided polygon, in particular a P3G polygon. The polygonal conical section with cross sections in the form of P3G polygons is particularly advantageous because in this way the torque transmission from the polygonal conical section of the crankshaft onto the support is possible with uniform stress distribution and the P3G polygon can be produced easily with comparatively minimal outer size or minimal inner size.

Advantageously, it is provided that on the support a magnet ring is arranged on which the at least one signal transducer is secured and that positioning means for positioning the magnet ring on the support relative to one of the sidelines of the polygonal conical section are provided. By means of the magnet ring, the signal transducer can be arranged in a simple way on the support. Due to the positioning means, a precise positioning of the magnet ring, and thus of the signal transducer, relative to one of the sidelines of the polygonal conical section is provided.

Advantageously, it is provided that a plurality of signal transducers are secured on the support in a circular arrangement about the axis of rotation at uniform spacings relative to each other. In this way, a plurality of signals can be generated by the different signal transducers for one revolution of the crankshaft in operation of the hand-guided power tool. In particular, the signal transducers are simultaneously part of a generator which is utilized for producing electric energy.

Advantageously, it is provided that the support is a flywheel. Advantageously, it is furthermore provided that the support is a fan wheel. The fan wheel comprises advantageously air guiding elements on the side facing away from the cylinder. The fan wheel serves preferably for supplying cooling air for the internal combustion engine.

Advantageously, it is provided that the signal transducer is a magnet which induces a voltage signal in a coil upon rotation of the support and that the voltage signal is the signal generated by the signal transducer. In this way, the signal generation can be realized in a simple way.

Advantageously, it is provided that the coil is part of the ignition device. The coil can serve for generating the signal as well as for generating the voltage required for generating the ignition spark.

Advantageously, it is provided that a pressure sensor is arranged on the crankcase for measuring the pressure in the crankcase. The pressure sensor measures at least at one certain point in time the pressure in the crankcase. The point in time for measuring the pressure is determined by the electronic control unit as a function of the signal generated by the signal transducer. In this way, the pressure in the crankcase can be determined at points in time at which the piston is in a predetermined position.

The internal combustion engine is in particular a two-stroke engine. By means of the pressure in the crankcase, the air-mass flow through the combustion chamber is in particular determined which can be utilized for determining the quantity of fuel to be supplied. For this purpose, the pressure in the crankcase is advantageously measured prior to and after transfer of combustion air into the combustion chamber. For pressure measurement, the crankcase is advantageously closed off relative to the intake passage and the combustion chamber. The pressure sensor is preferably a combination pressure-temperature sensor.

The method for producing a power tool provides that the crankshaft comprises an alignment element and that the polygonal conical section of the crankshaft is ground such that the polygonal section is oriented in a predefined way relative to the alignment element. In this way, the orientation of the polygon during production of the polygonal conical section is possible in a simple way at high precision.

As a result of introducing the polygonal conical section of the crankshaft into the polygonal conical receptacle of the support, the orientation of the support relative to the rotational position of the crankshaft is precisely predetermined. Depending on the configuration of the polygonal, a rotation of the support about the axis of rotation by one or a plurality of discrete angles may still be possible. This angle corresponds to the angle between two corners of the polygon. In this way, within a very narrow tolerance, a precise correlation between the angular position of the support and the orientation of the crankshaft and the position of the piston in the cylinder is provided.

Advantageously, it is provided that, prior to grinding the polygonal conical section into the crankshaft, an alignment of the crankshaft relative to a manufacturing device by means of geometric features of the crankshaft is realized. In this way, the polygonal conical section of the crankshaft can be ground in predefined orientation into the crankshaft. In this way, a simple alignment of the crankshaft relative to the manufacturing device is possible.

Advantageously, it is provided that the support is cast. In this way, the manufacture of the polygonal conical receptacle of the support and of the support itself is possible in a simple and precise way. The support is comprised preferably of aluminum, magnesium or plastic material. In particular, the support can be comprised of plastic material with a metal insert. The support can be comprised however also of other materials used in lightweight construction.

Advantageously, it is provided that the polygonal conical receptacle of the support is produced during casting of the support. Preferably, the receptacle of the support requires no finish machining after casting. In this way, the polygonal conical receptacle of the support can be produced in a simple way simultaneously with the production of the support in a single casting process. The receptacle can therefore be produced even with a small diameter. Finish machining of the polygonal conical receptacle of the support is not provided in this context.

Advantageously, it is provided that the support is cast or molded in a casting mold that is comprised of a plurality of casting mold parts, that on the support positioning means for positioning the magnetic ring on the support relative to the polygonal conical section are provided, and that the polygonal conical receptacle of the support and the positioning means are formed by the same casting mold part. Accordingly, since the positioning means and the polygonal conical receptacle are formed in the same casting mold part, a minimal tolerance of the relative position of positioning means and of the polygonal conical receptacle can be achieved when producing the support. Advantageously, the signal transducers are secured on the magnetic ring. As a result of the precise position of the positioning means relative to the polygonal conical section, the magnet ring and the signal transducer secured thereon are also precisely positioned relative to the polygonal conical receptacle on the support.

The described preferred embodiments can be combined in any way with each other. For example, an embodiment of the support of plastic material with a plurality of magnets would be conceivable also.

### BRIEF DESCRIPTION OF THE DRAWING

Embodiments of the invention will be explained in the following with the aid of the drawing in more detail.

FIG. 1 is a schematic partially sectioned side view of a motor chainsaw.

FIG. 2 is a schematic perspective and partially sectioned illustration of an internal combustion engine.

FIG. 3 is a schematic illustration of a section of a motor chainsaw.

FIG. 4 is an exploded illustration of crankshaft and fan wheel of the internal combustion engine.

FIG. 5 is a side view of crankshaft and fan wheel of FIG. 4 in the assembled state at bottom dead center.

FIG. 6 is a section along the section line VI-VI of FIG. 5.

FIG. 7 is a side view of the fan wheel in direction of arrow VII in FIG. 5.

FIG. 8 is partial illustration of a section along the section line VIII-VIII of FIG. 6.

FIG. 9 is a partial illustration of a section taken perpendicular to the axis of rotation of the crankshaft through the polygonal conical section of the crankshaft along the section line IX-IX of FIG. 8.

FIG. 10 is a side view of the crankshaft in the direction of arrow VII in FIG. 5.

FIG. 11 is a partial illustration of a side view in the direction of arrow XI of FIG. 10.

FIG. 12 is an exploded view of a fan wheel with magnet ring and with inertia ring.

FIG. 13 is a side view of the internal combustion engine with removed fan wheel.

FIG. 14 is a section along the section line XIV-XIV of FIG. 13.

FIG. 15 is a section perpendicular to the axis of rotation of the crankshaft through the claw pole generator, the magnet ring, the fan wheel, and the polygonal conical section of the crankshaft.

FIG. 16 is a schematic illustration of a section of a casting mold that contains a finish-molded fan wheel.

FIG. 17 is an enlarged illustration of the section view of FIG. 9.

FIG. 18 is an embodiment of a polygonal conical connection in a section illustration according to FIG. 17.

### DESCRIPTION OF THE PREFERRED EMBODIMENTS

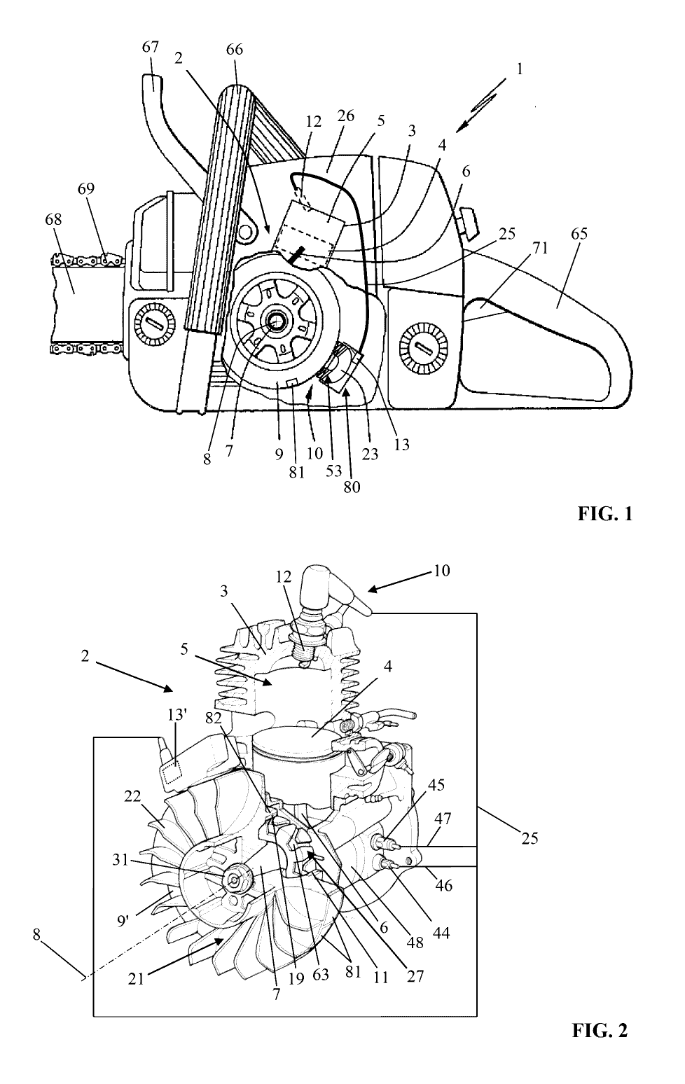

FIG. 1 shows a motor chainsaw as an exemplary embodiment of a hand-guided power tool 1. The power tool 1 can also be a cut-off machine, a blower, a trimmer or a similar portable hand-guided power tool.

The motor chainsaw comprises a motor housing 26 on which a guide bar 68 is secured. On the guide bar 68 a saw chain 69 is guided circumferentially. In the motor housing 26, an internal combustion engine 2 is arranged which drives the saw chain 69 in circulation about the guide bar 68 in operation. In the embodiment, the internal combustion engine 2 is designed as a mixture-lubricated two-stroke engine. For guiding the motor chainsaw in operation, on the motor housing 26 a rear handle 65 is arranged on which throttle lever 71 is pivotably supported. The internal combustion engine 2 can be operated by means of the throttle lever 71.

For guiding the motor chainsaw there is also a grip 66 that extends across the motor housing 26 of the motor chainsaw. The motor chainsaw comprises a hand guard 67 that extends on the side of the grip 66 which is facing the guide bar 68. The hand guard 67 serves advantageously for triggering a braking device (not illustrated) for the saw chain 69.

The internal combustion engine 2 comprises a cylinder 3 with a piston 4 that is reciprocatingly moving in the cylinder 3 and drives by means of connecting rod 6 a crankshaft 7. The crankshaft 7 rotates in operation about axis of rotation 8. In the cylinder 3, a combustion chamber 5 is formed which is delimited by the piston 4. A spark plug 12 projects into the combustion chamber 5. The spark plug 12 serves for igniting a mixture compressed within the combustion chamber 5.

A support is fixedly connected to the crankshaft 7 and rotates together with the crankshaft 7. In the embodiments, the support is designed as a fan wheel 9. The fan wheel 9 serves for conveying cooling air for the internal combustion engine 2. The fan wheel 9 serves preferably at the same time as a flywheel. The fan wheel 9 is comprised preferably of light metal, in particular magnesium or aluminum, or of plastic material. In the embodiments, all fan wheels are made of magnesium.

As is illustrated in FIG. 1, on the circumference of the fan wheel 9 at least one signal transducer is arranged which is designed as a magnet 81 in the embodiment according to FIG. 1. The magnet 81 rotates in operation together with the fan wheel 9 and interacts with a yoke 23 of an ignition module 80 which is arranged stationarily in the motor housing 26. Coils 53 are wound onto the two open ends of the yoke 23. In operation, the magnet 81 induces voltage in the coils 53 of the yoke 23 and generates thus an electric signal. The ignition module 80 comprises an electronic control unit 13 which is designed to determine the ignition timing at which an ignition spark is to be fired in the combustion chamber 5. Ignition timing refers in this context to the angular position of the crankshaft 7 at which ignition of the mixture in the combustion chamber is to be performed. The ignition module 80 is connected by ignition cable 25 with the spark plug 12. The magnet 81, the yoke 23, the coils 53, the ignition cable 25, and the spark plug 12 are part of an ignition device 10. As a function of the rotational position of the crankshaft 7 and thus as a function of the stroke position of the piston 4, the electronic control unit 13 triggers the ignition spark for combustion of the fuel/air mixture sucked into the combustion chamber 5. Determining the rotational position of the crankshaft 7 is realized by utilizing the signal generated by the at least one magnet 81 in the coils 53. In this context, the signal is advantageously utilized in order to determine the orientation of the fan wheel 9 on the crankshaft 7, i.e., the orientation of the polygonal conical section and receptacle relative to each other. The precise angular position of the fan wheel 9 on the crankshaft 7 is advantageously predetermined by means of the constructive configuration and is stored in the electronic control unit 13.

It can also be provided that the ignition timing of the ignition is determined directly by the voltage induced in the coils as a magnet passes the yoke. An ignition triggered in this way is referred to as magneto ignition. In magneto ignition, usually the ignition voltage required for producing the ignition spark is generated by induction of voltage in a coil by means of one or a plurality of permanent magnets. The induced voltage is intermediately stored in a capacitor. The signal which is generated by the signal transducer can then be utilized for triggering the ignition spark. The permanent magnet or the permanent magnets are preferably embedded by casting in the circumferential rim of the support.

The electronic control unit 13 determines the value for the ignition timing based on operating parameters such as rotary speed as well as based on measured values supplied to the electronic control unit 13, for example, the measured values for the temperature and the pressure in crankcase 48 (FIG. 2).

FIG. 2 shows the internal combustion engine 2 of the power tool 1 according to FIG. 1 wherein a fan wheel 9′ is provided instead of the fan wheel 9. The fan wheel 9′ is provided on the side 21 which is facing away from the cylinder 3 with air guiding elements 22. The fan wheel 9′ comprises on the side which is facing the cylinder 3 a receptacle 82 for a magnet ring 19. A cross section of the magnet ring 19 perpendicular to the axis of rotation 8 is circular. The center of the circular cross section of the magnet ring 19 is located on the axis of rotation 8. The magnet ring 19 is arranged on the inwardly positioned circumferential side of the receptacle 82 which is facing the axis of rotation 8. A plurality of magnets 11 are arranged in the magnet ring 19 and spaced apart at regular spacings relative to each other. The magnet ring 19 serves in the embodiment as a fastening ring for the magnets 11. The magnets 11 are part of a generator which is designed as a claw pole generator 27. The claws of the claw pole generator 27 surround coils 63 stationarily arranged on the crankcase 48; in the coils 63, voltage is induced and a signal is thus generated upon rotational movement of the magnet ring 19 and of the magnets 11 about axis of rotation 8.

The magnets 81 arranged on the outer circumference of the fan wheel 9′ serve in this embodiment, as in case of the fan wheel 9 in the embodiment according to FIG. 1, for generating by magnetic induction the energy required for ignition.

As shown in FIG. 2, on the crankcase 48 a pressure sensor 44 and a temperature sensor 45 are arranged which measure the pressure and the temperature in the crankcase 48. The pressure sensor 44 is connected by a cable 46 with an electronic control unit 13′. The electronic control unit 13′ replaces in this embodiment the control unit 13 of the embodiment according to FIG. 1. The temperature sensor 45 is connected by a cable 47 with the electronic control unit 13′.

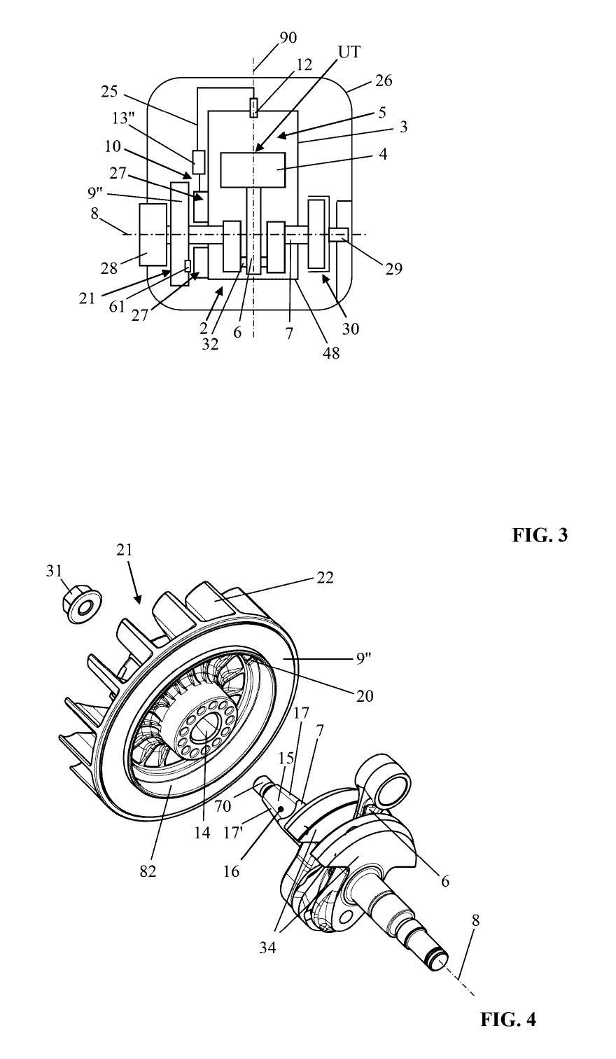

FIG. 3 shows in schematic illustration a section through the motor chainsaw according to FIG. 1 wherein a fan wheel 9″ is provided instead of the fan wheel 9 and an electronic control unit 13″ is provided instead of the electronic control unit 13. The section plane is defined by the axis of rotation 8 of the crankshaft 7 and the longitudinal cylinder axis 90 which is perpendicular to the axis of rotation 8. In FIG. 3, the crankshaft 7 is at bottom dead center UT. The crankshaft 7 comprises a crankpin 32. The piston 4 and the crankpin 32 have their maximum spacing relative to the spark plug 12 at bottom dead center UT.

As shown in FIG. 3, for starting the internal combustion engine 2, the power tool 1 comprises a starter device 28 which can be, for example, a cable pull starter or an electrically driven starter device. The rotational movement of the crankshaft 7 generated by the internal combustion engine 2, as shown in FIG. 3, is transmitted by a centrifugal clutch 30 onto a drive pinion 29 and is used in the embodiment for driving the saw chain illustrated in FIG. 1.

The claw pole generator 27 is part of the ignition device 10 and is utilized for generating the voltage required for firing the spark plug 12. The claw pole generator 27 is connected electrically conducting with the electronic control unit 13″. The signal generated by the magnets 61 is used in order to fire the spark plug 12 at an ignition timing which has been determined and preset by the electronic control unit 13″.

On the side of the fan wheel 9″ facing the cylinder 3, the magnet ring 19, not shown in FIG. 3, is arranged. FIG. 6 and FIG. 15 show that the magnet ring 19 has arranged thereat twelve magnets 61 in a circular arrangement about the axis of rotation 8. Neighboring magnets 61 in circumferential direction each have the same spacing b relative to each other which is measured in the circumferential direction about the axis of rotation 8.

In the embodiment according to FIG. 3, the signal transducer is at the same time also part of a rotor of the claw pole generator 27. The twelve magnets 61 together form the signal transducer in the embodiment according to FIG. 3. The magnets 61 generate a sinus-shaped signal. The signal generated by the signal transducer is used in the electronic control unit 13′ shown in FIG. 3 to fire the spark plug 12 at an ignition timing determined and preset by the electronic control unit 13′. For one revolution of the fan wheel 9″ with magnets 61, a sinus-shaped signal with twelve sinus periods is generated by the signal transducer. For example, the electronic control unit 13″ determines that one of the twelve sinus period that is generated when the piston 4 and the crankpin 32 are at bottom dead center UT. This specific sinus period of the signal generated by the signal transducer is referred to as UT sinus period in the following. For determining the point in time of ignition, any other sinus period can however be utilized also. In order to identify the UT sinus period, the measured signals of the pressure sensor 44, illustrated in FIG. 2 and provided to measure the crankcase pressure, are supplied to the electronic control unit 13″, for example. The crankcase pressure changes as a function of the angular position of the crankshaft 7 relative to the axis of rotation 8 of the crankshaft 7, i.e., as a function of the crank angle. When the crank angle of the crankshaft 7 is in the area of the angular position of bottom dead center UT, the crankcase pressure in operation is at its highest value. Typically, it is reached a few angular degrees prior to reaching bottom dead center UT.

For precise determination of bottom dead center UT, the actual angular position illustrated in FIG. 6 for the individual magnets 61 at bottom dead center UT and the nominal angular position of the magnets 61, stored in the electronic control unit 13″, have a deviation relative to each other that is as small as possible. The relative position of the crankpin 32 (FIG. 3) and of the magnets 61 must be determined sufficiently precisely. When determining in one of the electronic control units 13, 13′, and 13″ the timing at which the spark plug 12 is to be fired, the precise relative position of the magnets 11, 61 or 81 relative to the crankshaft 7 is decisive. As illustrated in FIG. 4, a polygonal cone connection between the crankshaft 7 and the fan wheel 9″ is provided for this purpose. The crankshaft 7 comprises a polygonal conical section 15 at its end which is facing the fan wheel 9″. The fan wheels 9 and 9′ according to FIGS. 1 and 2 are designed correspondingly. The polygonal cone connection between fan wheel 9″ and crankshaft 7 enables in the embodiment of FIG. 4 precisely three relative rotational positions of support and crankshaft 7. When the UT sinus period is identified, the rotational position of support and crankshaft 7 can be precisely determined. In this way, it is possible to trigger the ignition of mixture in the combustion chamber 5 comparatively precisely at the ignition timing that is determined by the electronic control unit 13″. This applies likewise to the electronic control units 13 and 13′ of FIGS. 1 and 2.

In FIG. 9, a cross section of the polygonal cone-shaped section 15 perpendicular to the axis of rotation 8 of the crankshaft 7 is illustrated. The polygon illustrated in this cross section is a P3G polygon. The P3G polygon is referred to as same thickness profile because all diameters of the profile or of the cross section of the polygonal conical section 15 that are extending perpendicular to the longitudinal axis (axis of rotation 8) and are passing through the longitudinal axis (axis of rotation 8) are of the same length. As can be seen in FIG. 4 and FIG. 9, the polygonal conical section 15 of the crankshaft 7 comprises precisely three sidelines 17, 17′, 17″ that extend substantially in the direction of the axis of rotation 8.

In FIG. 8, section planes S, S′ are shown in an exemplary fashion. The section planes S, S′ extend perpendicular to the axis of rotation 8 and intersect the polygonal conical section 15. Each section plane S, S′ intersects the three sidelines 17, 17′, 17″ (FIG. 9). The points of intersection of the sidelines 17, 17′, 17″ with one of the section planes S, S′ indicate points 18, 18′, 18″ of the circumferential surface 16 of the polygonal conical section 15 which have the greatest spacing a from the axis of rotation 8 in this section plane. As illustrated in FIG. 4, the cross section of the polygonal conical section 15 perpendicular to the axis of rotation 8 decreases in the direction away from the crankwebs 34 of the crankshaft 7. The three sidelines 17, 17′, 17″ extending in a circumferential surface 16 of the polygonal conical section 15 converge in the direction of the longitudinal axis (axis of rotation 8) in the direction away from the crankwebs 34.

On the side of the polygonal conical section 15 facing away from the crankwebs 34, the crankshaft 7 comprises at its end a threaded pin 70. The longitudinal symmetry axis of the threaded pin 70 is coaxial to the axis of rotation 8. The diameter of the threaded pin 70 is smaller than the diameters of the profile or of the cross section of the polygonal conical section 15 that are extending perpendicular to the longitudinal axis (axis of rotation 8) and passing through the longitudinal axis (axis of rotation 8).

FIG. 4 shows adjacent to the crankshaft 7 a support which is designed as fan wheel 9″ and in operation rotates about the axis of rotation 8. In the area of the axis of rotation 8, a polygonal conical receptacle 14 is arranged in the fan wheel 9″. The polygonal conical receptacle 14 extends in the direction of the axis of rotation 8 of the crankshaft 7. The polygonal conical receptacle 14 forms a continuous through opening passing through the fan wheel 9″. The polygonal conical receptacle 14 of the fan wheel 9″ corresponds with (matches) the polygonal conical section 15. The outer contour of the polygonal conical section 15 has the shape of a P3G polygon in a cross section taken perpendicular to the axis of rotation 8 through the polygonal conical section 15. The cross section of the polygonal conical receptacle 14 decreases in the direction of the axis of rotation 8 in the direction away from the cylinder 3. In the assembled state, the crankshaft 7 is connected by means of its polygonal conical section 15 with form fit to the fan wheel 9″ by means of the polygonal conical receptacle 14. In this context, the polygonal conical section 15 of the crankshaft 7 is pushed into the polygonal conical receptacle 14 of the fan wheel 9″. The threaded pin 70 of the crankshaft 7 is pushed through and projects from the side 21 of the fan wheel 9″ which is facing away from the cylinder 3. Onto the external thread of the threaded pin 70, a fixation nut 31 is screwed. By means of the fixation nut 31, the polygonal conical section 15 of the crankshaft 7 is pressed into the polygonal conical receptacle 14 of the fan wheel 9″.

FIG. 4 shows also the receptacle 82 which is arranged on the side of the fan wheel 9″ that is facing the cylinder 3. The magnet ring 19, not shown in FIG. 4, is introduced into the receptacle 82. For positioning the magnet ring 19, first positioning means 200 and second positioning means 20 are provided in the receptacle 82 in the embodiment; the positioning means 20, 200 are shown in FIG. 4 and also in FIG. 12. The positioning means 20, 200 in the embodiment are formed as recesses which are provided in the bottom of the receptacle 82. The recesses in the bottom of the receptacle 82 of the fan wheel 9″ corresponds with positioning means 37 of the magnet ring 19 illustrated in FIG. 12. The positioning means 37 of the magnet ring 19 are noses projecting past the edge of the magnet ring 19 and extend in a direction away from the cylinder 3 in the direction of the axis of rotation 8 of the crankshaft 7. By interaction of the positioning means 20, 200 of the fan wheel 9″ and of the positioning means 37 of the magnet ring 19, the position of the magnet ring 19 on the fan wheel 9″ is precisely and unequivocally determined.

The polygon connection according to FIG. 4 is provided for all illustrated embodiments, even when this detail is not illustrated for all illustrated fan wheels. Also, the fan wheels 9 and 9′ comprise the polygonal conical receptacle 14 illustrated in FIG. 4, respectively. Also, the fan wheel 9′ comprises receptacle 82 and positioning means 20, 200 even through this is not illustrated for the fan wheel 9′ in the drawing.

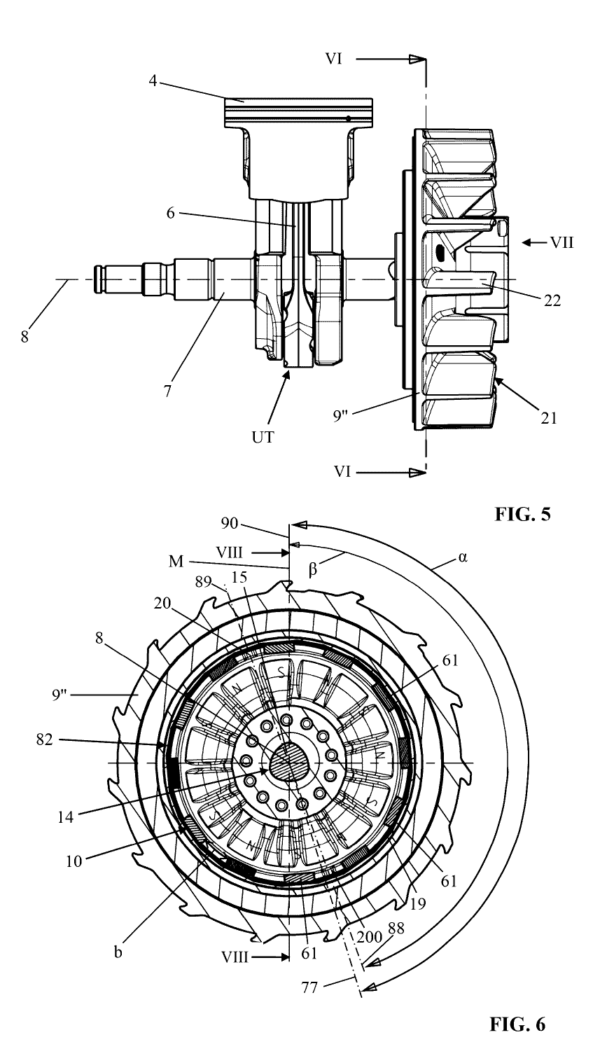

FIG. 5 shows the fan wheel 9″ and the crankshaft 7 in the assembled state in a side view. The piston 4, the connecting rod 6, and the crankshaft 7 in the illustrated view are at bottom dead center UT. The stator of the claw pole generator 27 arranged between the crankwebs 34 and the fan wheel 9″ is not illustrated in FIGS. 5 to 8.

FIG. 6 shows a section along the section line VI-VI of FIG. 5. The section plane is perpendicular to the axis of rotation 8 of the crankshaft 7 and intersects the fan wheel 9″ as well as the magnet ring 19 with magnets 11 fixed on the magnet ring 19. The cross section of the magnet ring 19 is circular in the illustrated section plane.

The center of the circular cross section of the magnet ring 19 is positioned on the axis of rotation 8 of the crankshaft 7. On the inner side of the magnet ring 19 facing the axis of rotation 8, the twelve magnets 61 are arranged. The magnets 61 are permanent magnets. In relation to the circumferential direction about the axis of rotation 8, the magnetic flux lines of magnets 61 neighboring each other in circumferential direction are oriented at least partially in opposite directions. The magnets 61 are part of the rotor of the claw pole generator 27 which is not shown completely in FIG. 6.

The position of the magnets 61 relative to the fan wheel 9″ is determined by their arrangement on the magnetic ring 19 and by the arrangement of the magnetic ring 19 on fan wheel 9″. The position of the magnetic ring 19 relative to the fan wheel 9″ is determined by the interaction of the positioning means 37 (FIG. 12) of the magnet ring 19 and the positioning means 20, 200 of the receptacle 82 of the fan wheel 9″. The positioning means 37 are advantageously designed as noses and the positioning means 20, 200 are designed as recesses. The noses engage with form fit the recesses. In the embodiment according to FIG. 6, two recesses which in relation to the axis of rotation 8 are diametrically opposite each other are provided as positioning means 20, 200. At bottom dead center UT, the first positioning means 200 is below the axis of rotation 8 and is farther removed from the spark plug 12 (FIG. 3) than the second positioning means 20.

The first positioning means 200 comprises a symmetry axis 89 which is extending radially to the axis of rotation 8. The position of the symmetry axis 89 marks an actual position 88 of the signal transducer formed by the magnets 61. The twelve magnets 61 together form the signal transducer in the embodiment of FIG. 6. The actual position 88 is a rotational position of the positioning means 200 about the axis of rotation 8 and is illustrated in the Figure by a dash-dotted line extending radially relative to the axis of rotation 8. The angular position is indicated relative to that point where the first positioning means 200 is located, namely above the axis of rotation 8, i.e., closer to the spark plug 12, in a plane M that is defined by the longitudinal cylinder axis 90 and the axis of rotation 8. This corresponds in the position illustrated in FIG. 6 to the uppermost position of the first positioning means 200, i.e., a position of the first positioning means 200 at top dead center. At this point, the angular position of the symmetry axis is 0°. At bottom dead center UT (FIGS. 3, 5, and 10) of the piston 4, the angular position of the symmetry axis, i.e., the actual position 88 of the signal transducer, is indicated by angle β relative to top dead center. In the embodiment according to FIG. 6, the angle β is approximately 160°.

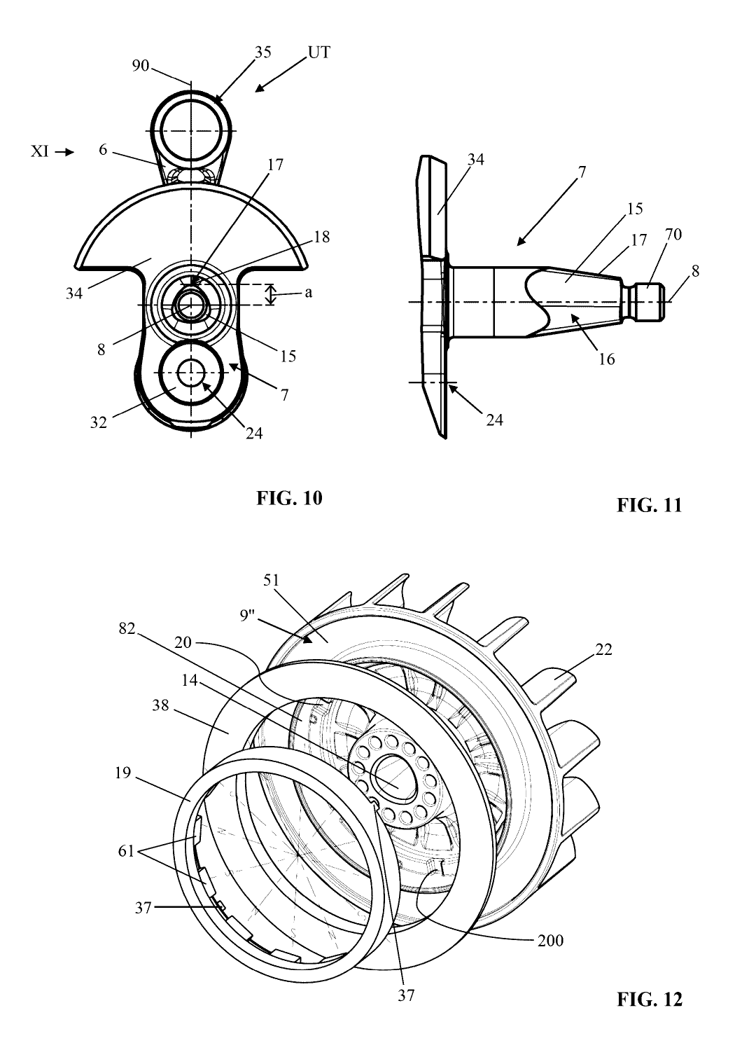

In the electronic control unit 13, 13′, 13″ according to FIG. 1 to FIG. 3, an angle α for a nominal position 77 of the signal transducer defined for a predetermined position of the piston 4 in the cylinder 3 is stored. In the embodiment according to FIG. 6, the angle α for bottom dead center UT is precisely 160°. The nominal position 77 of the signal transducer is the desired angular position of the signal transducer for the predetermined position of the piston 4 in the cylinder 3. In the embodiment, the predetermined position of the piston 4 in the cylinder is bottom dead center UT illustrated in FIG. 3, FIG. 5, and FIG. 10.

In FIG. 6, the illustration of the angular spacing between the actual position 88 of the signal transducer and the nominal position 77 of the signal transducer, i.e., the difference between angle β and angle α, is exaggerated. In reality, the difference between the value β and the value α is less than 2.5°, in the embodiment less than 2°. The deviation between the nominal position 77 and the actual position 88 corresponds to the tolerance which must be observed for positioning the signal transducer relative to the fan wheel 9″. Based on the sinus signal which is produced in operation by the signal transducer and after identification of the UT sinus period, it can be deduced when the signal transducer is in its nominal position 77 based on the course of the sinus signal in the UT sinus period. Due to the minimal deviation of the actual position 88 from the nominal position 77 at bottom dead center UT, the point in time when the crankshaft 7 and thus the piston 4 (FIG. 3) are at bottom dead center UT can be detected with a very minimal imprecision by the electronic control unit 13″. Based on this precise information, the spark plug 12 can be fired by the electronic control unit 13″ comparatively precisely at the ignition timing determined by the electronic control unit 13″.

The precise position determination of the piston 4 by means of the signal generated by the signal transducer can be utilized for detection of any predetermined position of the piston 4 in the cylinder 3. For example, it can also be provided that the pressure sensor 44 illustrated in FIG. 2 measures the pressure in the crankcase 48 at a certain point in time when the piston 4 is at a certain position. The determination of this point in time can be realized in the electronic control unit 13″ based on the signal. In this way, for example, the determination of the air-mass flow from crankcase 48 into the combustion chamber 5 is possible. For this purpose, the pressure in the crankcase 48 is measured at two points in time, in particular prior to and after transfer of combustion air into the combustion chamber 5, wherein the crankcase 48 for pressure measurement is closed off relative to the intake passage and the combustion chamber 5. Since the position of the piston 4 at the two points in time is known, the volume of the crankcase 48 at the two points in time is also known. By means of the ideal gas law, the air mass that has been transferred between the two points in time from the crankcase 48 into the combustion chamber 5 can be calculated based on the measured pressures and the volumes of the crankcase 48.

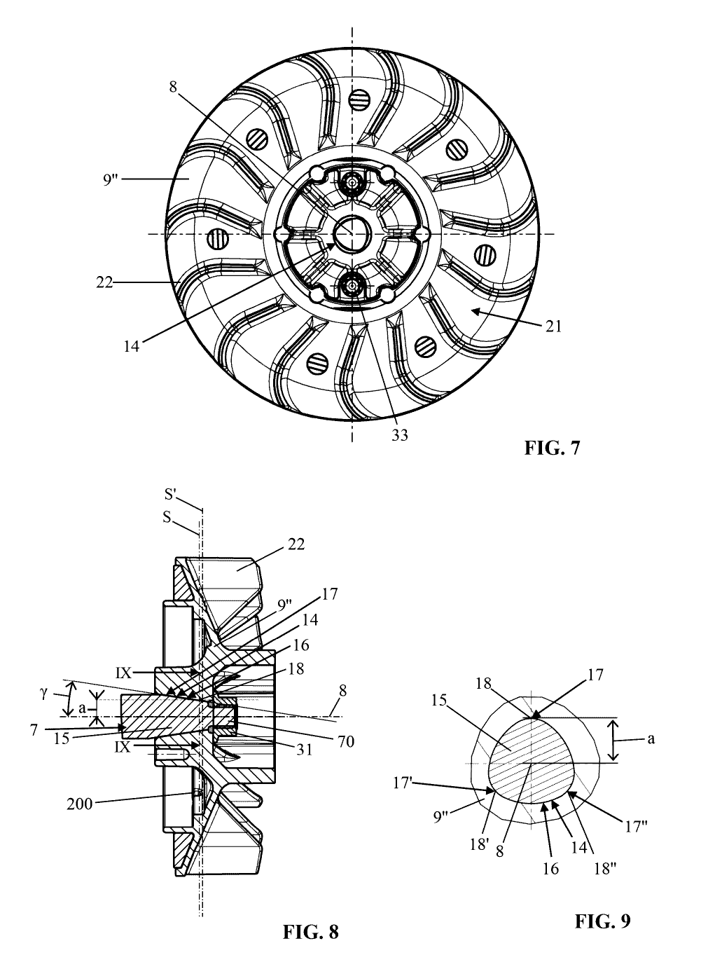

FIG. 7 shows a plan view of the fan wheel 9″ of FIG. 4 through 6 in the direction of the axis of rotation 8 of the crankshaft 7, viewed from the side 21 of the fan wheel 9″ facing away from the cylinder 3. FIG. 7 shows exclusively the fan wheel 9″. The crankshaft 7 is not illustrated in FIG. 7. On the side 21 of the fan wheel 9″ facing away from the cylinder 3, air guiding elements 22 are arranged. The air guiding elements 22 in the form of vanes are arranged about the axis of rotation 8. The polygonal conical receptacle 14 of the fan wheel 9″ has on the side 21 of the fan wheel 9″ its smallest cross section perpendicular to the axis of rotation 8. Beginning at the side 21 of the fan wheel 9″, threaded bores 33 are introduced into the fan wheel 9″ that advantageously extend in the direction of the axis of rotation 8. For demounting the fan wheel 9″, threaded bolts are screwed into the threaded bores 33. The fan wheel 9″ can be easily removed by means of the threaded bolts.

FIG. 8 shows a section through the fan wheel 9″ and the polygonal conical section 15 as well as the threaded pin 70 of the crankshaft 7. The stator of the claw pole generator 27 is not shown in FIG. 8. The longitudinal cylinder axis 90 and the axis of rotation 8 define a plane M (FIG. 6) which is at the same time the section plane. As shown in FIG. 8, the circumferential surface 16 of the polygonal conical section 15 of the crankshaft 7 is oriented in the plane M at an angle γ of 6° to 12°, in particular 8.5° to 10°, relative to the axis of rotation 8. The circumferential surface 16 is advantageously also oriented at an angle γ of 6° to 12°, in particular 8.5° to 10°, relative to the axis of rotation 8 in any other plane containing the axis of rotation 8.

In the illustration shown in FIG. 8, the crankshaft 7 is at bottom dead center UT (FIG. 5). At bottom dead center UT, the sideline 17 of the three sidelines 17, 17′, 17″ of the polygonal conical section 15 is located in the plane M. On the sidelines 17, 17′, 17″, points 18, 18′, 18″ are located which in the section planes S, S′ (FIG. 8) have perpendicular to the axis of rotation 8 the greatest spacing a relative to the axis of rotation 8. The point 18 is located on the sideline 17. The sideline 17 which is visible in FIG. 8 is positioned at bottom dead center UT above the axis of rotation 8, i.e., of the three sidelines 17, 17′, 17″ of the polygonal conical section 15 the sideline 17 is the one closest to the spark plug 12.

FIG. 9 shows a cross section of the polygonal conical section 15 of the crankshaft 7. The corresponding section plane S extends perpendicular to the axis of rotation 8 and is shown in FIG. 8. In FIG. 9, three points 18, 18′, 18″ are shown which all have the same greatest spacing a relative to the axis of rotation 8. The three points 18, 18′, 18″ are each part of three different sidelines 17, 17′, 17″ of the polygonal conical section 15. As shown in FIG. 8 and FIG. 9, the polygonal conical section 15 of the crankshaft 7 is enclosed with form fit by the polygonal conical receptacle 14 of the fan wheel 9″.

FIG. 10 shows a plan view of the crankshaft 7 and of the connecting rod 6 arranged between the crankwebs 34. The crankshaft 7 is at bottom dead center UT. The crankweb 34 is connected to crankpin 32. The polygonal conical section 15 of the crankshaft 7 is ground such that the polygonal conical section 15 is oriented to the alignment element 24 in a predefined way. As alignment element 24 for the polygonal conical section 15, for example, the crankpin 32 or the crankpin bore can be used. The sideline 17 of the polygonal conical section 15 points toward the crankpin 32. Another section of the crankshaft 7 can be used also as an alignment element 24.

FIG. 11 shows a side view of a portion of the crankshaft 7 wherein only one of the two crankwebs 34 is illustrated.

FIG. 12 shows an exploded illustration of the fan wheel 9″, of the magnet ring 19, and of an inertia ring 38. The density of the material of the inertia ring 38 is greater than the density of the material of the fan wheel 9″. By use of the inertia ring 38, the mass distribution of the system of the fan wheel 9″ and inertia ring 38 is particularly beneficial. Due to the inertia ring 38 it is possible to attach a great mass remote from the axis of rotation 8 on the fan wheel 9″. In this way, a greater moment of inertia is provided while at the same time a low weight of the system of fan wheel 9″ and inertia ring 38 is provided. Due to the comparatively high moment of inertia, the system of fan wheel 9″ and inertia ring 38 can be used as a flywheel.

In the assembled state, the inertia ring 38 is arranged on the side of the fan wheel 9″ which is facing the cylinder 3. The inner diameter of the inertia ring 38 is greater than the outer diameter of the magnet ring 19. The magnet ring 19 is arranged at the center of the inertia ring 38 and is surrounded by the inertia ring 38. The magnet ring 38 is preferably adhesively connected in a circular ring-shaped receptacle 51 of the fan wheel 9″.

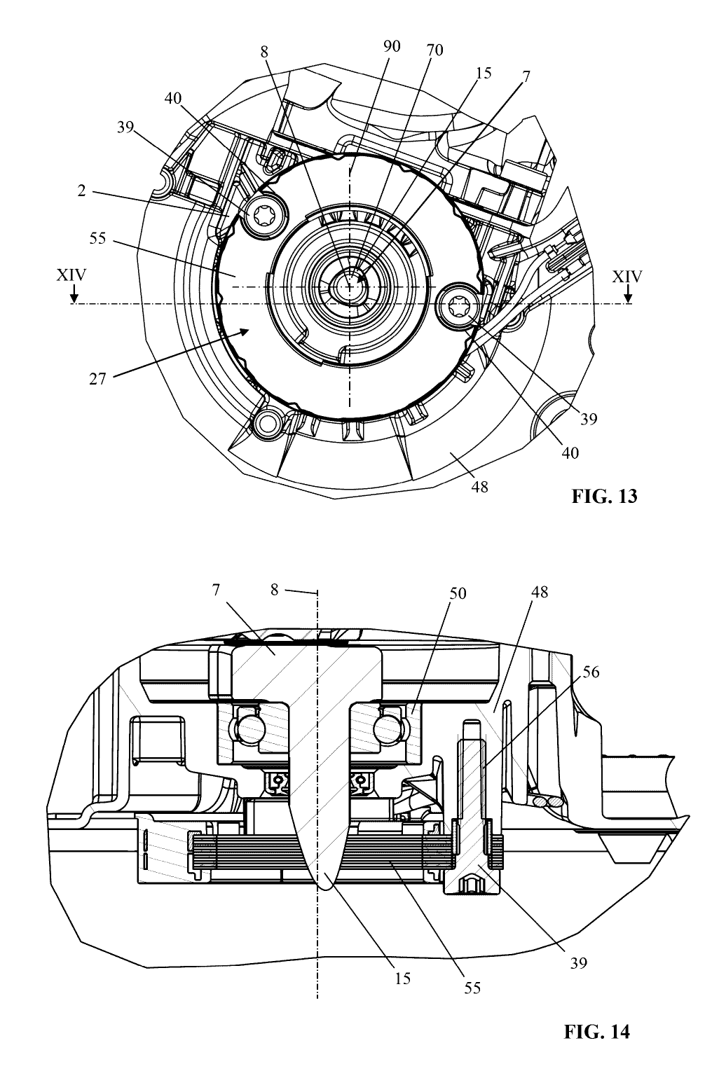

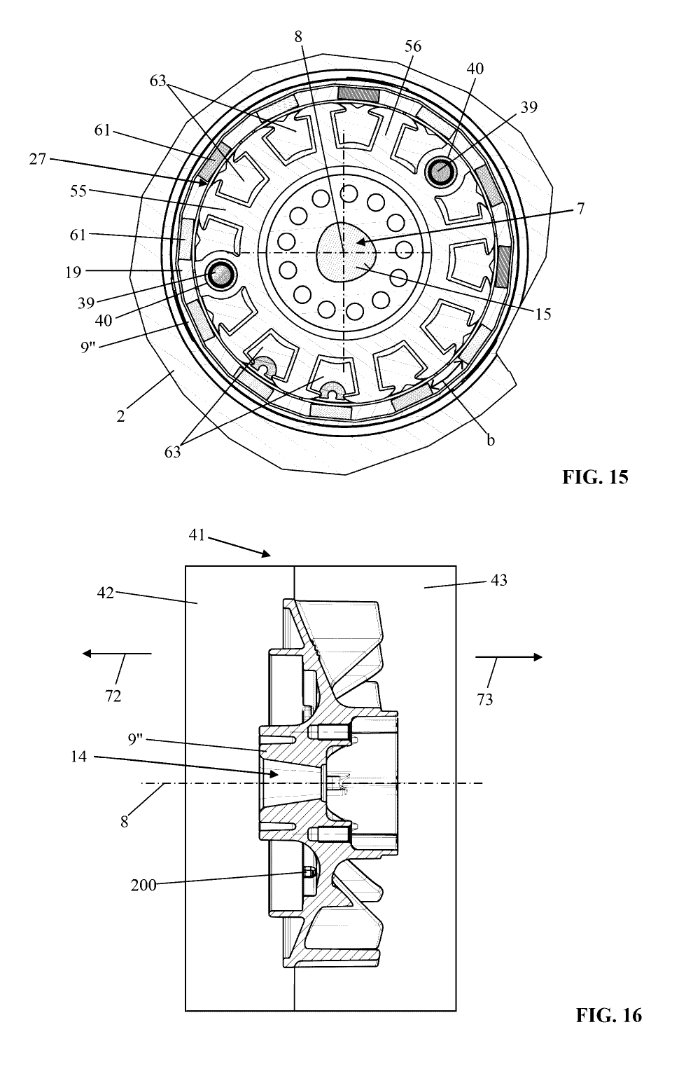

FIG. 13 shows in plan view the stator 55 of the claw pole generator 27 which is fastened on the crankcase 48 of the internal combustion engine 2. In the stator 55 bores 40 are provided which extend in the direction of the axis of rotation 8. Screw bolts 39 are inserted flush through the bores 40 for attachment of the stator 55 on the crankcase 48. Threaded bores 56, shown in FIG. 14, are provided in the crankcase 48 for the screw bolts 39. In the embodiment according to FIG. 14, two bores 40 are provided which are arranged on the circumferential rim of the substantially cylinder-shaped stator 55. The bores 40 can be produced with high precision so that the position of the stator 55 relative to the internal combustion engine 2 and relative to the crankcase 48 is precisely determined and thus also the position of the coils 63 of the stator 55, illustrated in FIG. 15, relative to the actual position 88 of the signal transducer at bottom dead center UT. Since the position of the coils 63 is known and determined, by means of the voltage signal produced by the signal transducer in the coils 63 the actual position 88 or the presence of the nominal position 77 of the signal transducer can be deduced.

FIG. 14 shows a section of one of the two screw bolts 39 and of the polygonal conical section 15 of the crankshaft 7 along the section line XIV-XIV of FIG. 13; the section line XIV-XIV is extending perpendicular to the cylinder axis 90. The crankshaft 7 is rotatably supported in a crankshaft bearing 50 so as to rotatable about axis of rotation 8. As illustrated in FIG. 14, the longitudinal direction of the screw bolts 39 extends parallel to the axis of rotation 8. The screw bolt 39 is screwed into the threaded bore 56 of the crankcase 48.

FIG. 15 shows a section perpendicular to the axis of rotation 8 of the crankshaft 7 of the power tool 1 through the claw pole generator 27, the magnet ring 19, the fan wheel 9″ and the polygonal conical section 15 of the crankshaft 7. The claw pole generator 27 comprises the stator 55 and the rotor which is formed by the fan wheel 9″, the magnetic ring 19, and the magnets 61 fixed on the magnetic ring 19. Between the claws of the stator 55 of the claw pole generator 27 mushroom heads 56 of the stator 55 are arranged. The longitudinal directions of the mushroom heads 56 extend radially to the axis of rotation 8. The head portions of the mushroom heads 56 are positioned externally in radial direction relative to the axis of rotation 8. The mushroom heads 56 have stem-shaped sections about which the coils 63 are wound. In operation, a voltage signal for determining the point in time at which the spark plug 12 (FIG. 3) is to be fired is generated in the coils 63 by the magnets 61. The coils 63 are part of the ignition device 10 illustrated in FIG. 3. The voltage induced in the coils 63 is not only used for determining the point in time at which the spark plug 12 is to be fired but also for generating the required ignition voltage for firing the spark plug 12.

FIG. 16 shows a schematic illustration of a casting mold 41. The casting mold 41 comprises two casting mold parts 41, 42. In the illustration of FIG. 16, the casting mold 41 is closed and contains a finish-cast fan wheel 9″. When casting the fan wheel 9″, the positioning means 20, 200 and the polygonal conical receptacle 14 are molded by the same casting mold part 42. After casting in the casting mold 41, the polygonal conical receptacle 14 of the fan wheel 9″ is finished. No further machining of the polygonal conical receptacle 14 is required. For removing the fan wheel 9″ after casting, the casting mold part 42 is guided in the direction of a removal direction 72 and the casting mold part 42 in the direction of a removal direction 73. The removal direction 72 and the removal direction 73 are oriented opposite to each other and extend both parallel to the axis of rotation 8.

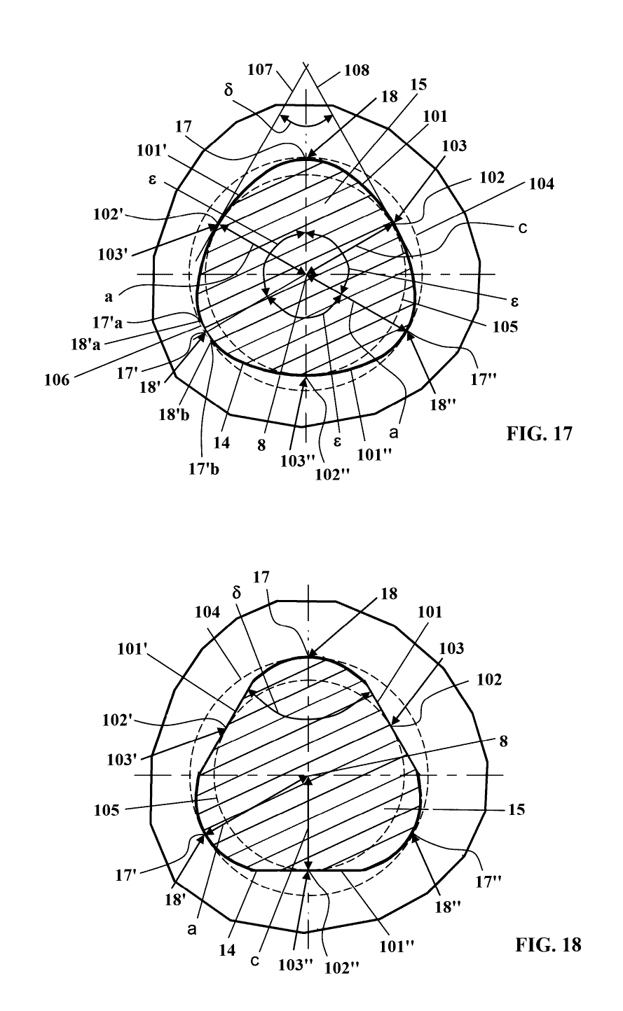

FIG. 17 shows the cross section of the polygonal conical section 15 and of the polygonal conical receptacle 14 in detail. As shown in FIG. 17, the cross sections of the polygonal conical section 15 and of the polygonal conical receptacle 14 correspond to each other. The spacing of a point of the cross section of the polygonal conical section 15 relative to the axis of rotation 8 of the crankshaft 7 corresponds in approximation to the spacing of the point of the polygonal conical receptacle 14 arranged at the same location. The polygonal conical receptacle 14 and the polygonal conical section 15 have, with the exception of production-caused tolerances, at any point the same spacing relative to the axis of rotation 8.

Between the points 18, 18′, 18″ that each have the greatest spacing a relative to the axis of rotation 8, the lateral surfaces 101, 101′, 101″ are extending. The lateral surfaces 101, 101′ and 101″ have each points 103, 103′, 103″ that have a smallest spacing c relative to the axis of rotation 8. Advantageously, the spacing c is approximately 4 mm to 10 mm. The spacing a is advantageously approximately 5 mm to 15 mm. In a particularly advantageous configuration, the spacing c amounts to 6 mm to 7 mm and the spacing a amounts to 7 mm to 9 mm.

The points 103, 103′, and 103″ are positioned on sidelines 102, 102′ and 102″. The lateral surface 101 extends from the sideline 17″ to the sideline 17 and contains the sideline 102. The lateral surface 101′ extends from the sideline 17 to the sideline 17′ and contains the sideline 102′. The lateral surface 101′ extends from the sideline 17′ to the sideline 17″ and contains the sideline 102″. Each lateral surface 101, 101′, 101″ comprises a length ε measured as an angle about the axis of rotation 8. In the embodiment, the length ε for each lateral surface 101, 101′, 101″ is the same and amounts to 120°. Preferably, the length ε amounts to 360° divided by the number of lateral surfaces 101, 101′, 101″. The points 103, 103′, 103″ are positioned on an inner circle 105 of each cross section. The inner circle 105 has a radius which corresponds to the spacing c. Each cross section of the polygonal conical section 15 perpendicular to the axis of rotation 8 has an outer circle 104 on which the sidelines 17, 17′ and 17″ are located. The radius of the outer circle 104 corresponds to the spacing a. The ratio of the radius of the outer circle 104 to the radius of the inner circle 105 advantageously amounts to 1.05 to 1.2, in particular 1.09 to 1.15.

As also shown in FIG. 17, the sidelines 17, 17′, and 17″ are each located in the area of a curvature. Also, the sidelines 102, 102′, and 102″ are each located in the area of a curvature. In the embodiment according to FIG. 17, the polygonal conical section in cross section is formed with a continuous curvature. The polygonal conical section 15 comprises therefore no straight area at its exterior side.

In an alternative embodiment, instead of the sidelines 17, 17′, 17″ the flat area 106 can be provided which is indicated schematically by means of a dashed white line in FIG. 17 in the area of the sideline 17′. Preferably, at each sideline 17, 17′, 17″ a flat area 106 is arranged. In particular, all flat areas 106 are identically embodied. The flat area 106 is advantageously very small. The width of the flat area 106 amounts advantageously to 0.2 mm to 1.5 mm, in particular 0.3 mm to 1.0 mm. In the embodiment, a flat area 106 is provided with a width of approximately 0.5 mm measured in circumferential direction. As also shown in FIG. 17, at the ends of the flat area arranged in the circumferential direction, points 18′a and 18′b are provided which have the greatest spacing to the axis of rotation 8. The points 18′a and 18′b are positioned on sidelines 17′a and 17′b. As a result of the minimal width of the flat area 106, the point 18′ can be considered to be in approximation a point with the greatest spacing to the axis of rotation 8 of the crankshaft 7 and the sideline 17′ can be considered in approximation the sideline on which the points with the greatest spacing to the axis of rotation 8 are located. The same holds true also for the sidelines 17 and 17″ as well as the points 18 and 18″ when corresponding flat areas 106 are provided here also.

In the area of the sidelines 17, 17′, 17″, the cross section of the polygonal conical section 15 is extending at a radius that is smaller than the radius of the inner circle 105. In the area of the sidelines 102, 102′, 102″, the cross section extends at a radius which is greater than the radius of the inner circle 105, in particular greater than the radius of the outer circle 104. The center point of the inner circle 105 and the center point of the outer circle 104 are positioned on the axis of rotation 8, respectively. The neighboring lateral surfaces 101, 101′, 101″ are positioned at an angle δ relative to each other which amounts to 60° in the embodiment. The angle δ is advantageously not greater than 180°. The angle δ is measured at the circumferential center of the lateral surfaces 101, 101′ 101″ viewed in the circumferential direction, respectively. Since the lateral surfaces 101, 101′ and 101″ are curved, the angle δ is measured between tangents 107 and 108 at the circumferential centers of the lateral surfaces 101, 101′, 101″. The angle δ opens in the direction toward the axis of rotation 8 and is measured in the area between the lateral surfaces 101, 101′, 101″ in which the axis of rotation 8 is located.

In the embodiment, the cross section of the polygonal conical section 15 is uniformly configured. All lateral surfaces 101, 101′, and 101″ are identical. The length ε measured in circumferential direction as well as the shape of the lateral surfaces 101, 101′ and 101″ is identical. Also, the radius between the lateral surfaces 101, 101′, and 101″ which is extending along the sidelines 17, 17′, and 17″ is identical. The curvature of the polygonal conical section 15 is convexly formed in any area. The polygonal conical section 15 comprises no recesses, depressions or the like. The cross section extends continuously. The cross section has no edges or corners. The polygonal conical section 15 comprises the shape of a polygon, in the embodiment the shape of a triangle, in which the corners and the lateral surfaces are embodied with a rounded shape.

In an alternative configuration, the lateral surfaces 101, 101′, 101″ can be extending partially straight. This is schematically shown in FIG. 18. The points 103, 103′, and 103″ that have the smallest spacing c relative to the axis of rotation 8, respectively, are arranged in the illustrated embodiment of FIG. 18 in a flat area of the exterior surface of the polygonal conical section 15. In comparison to the embodiment shown in FIG. 17, the spacing c of the points 103, 103′, and 103″ relative to the axis of rotation 8 is smaller in FIG. 18. The spacing a of the points 18, 18′ and 18″ is the same as in the embodiment of FIG. 17. With the exception of the straight area of the lateral surfaces 101, 101′, and 101″ the cross section of the polygonal conical section 15 and of the polygonal conical receptacle 14 corresponds to the configuration of FIG. 17. Also, in the embodiment according to FIG. 18, flat areas 106 can be provided additionally on the sidelines 17, 17′, 17″.

The lateral surfaces in all embodiments are lateral surfaces of the polygonal conical section.

The specification incorporates by reference the entire disclosure of European priority document 15 003 564.0 having a filing date of Dec. 15, 2015.

While specific embodiments of the invention have been shown and described in detail to illustrate the inventive principles, it will be understood that the invention may be embodied otherwise without departing from such principles.

What is claimed is:

1. A hand-guided power tool comprising:
an internal combustion engine comprising a cylinder and a piston, disposed in the cylinder and delimiting together with the cylinder a combustion chamber, and further comprising a crankshaft and a connecting rod connecting the piston and the crankshaft, wherein the piston in operation of the internal combustion engine rotatably drives the crankshaft about an axis of rotation of the crankshaft;
an electronic control unit;
an ignition device comprising a spark plug;
a support fixedly connected to the crankshaft;
at least one signal transducer fixedly connected to the support;
wherein the ignition device, utilizing a signal generated by the at least one signal transducer, fires the spark plug at a timing which is predetermined by the electronic control unit;
wherein the support comprises a polygonal conical receptacle;
wherein the crankshaft comprises a polygonal conical section corresponding with the polygonal conical receptacle of the support and arranged in the polygonal conical receptacle of the support to fixedly connect the support and the crankshaft to each other.

2. The hand-guided power tool according to claim 1, wherein the polygonal conical section comprises a cross section that deviates from a circular shape.

3. The hand-guided power tool according to claim 1, wherein the polygonal conical section comprises two or more lateral surfaces that are flattened relative to a circular cone shape.

4. The hand-guided power tool according to claim 3, wherein at least one of the two or more lateral surfaces is at least partially rounded.

5. The hand-guided power tool according to claim 3, wherein the two or more lateral surfaces are at least partially rounded.

6. The hand-guided power tool according to claim 1, wherein the polygonal conical section comprises two to nine flattened lateral surfaces.

7. The hand guided power tool according to claim 1, wherein the polygonal conical section comprises two or more lateral surfaces that are flattened, wherein the two or more lateral surfaces each have a circumferential center relative to a circumferential direction of the polygonal conical section, wherein an angle between two of the lateral surfaces that are neighboring each other in a circumferential direction of the polygonal conical section is measured between the circumferential centers of said two lateral surfaces and wherein the angle is not greater than 180°.

8. The hand-guided power tool according to claim 1, wherein the polygonal conical section comprises two or more lateral surfaces that are flattened, wherein a ratio of the number of the signal transducers on the support relative to the number of the lateral surfaces is an integer.

9. The hand-guided power tool according to claim 1, wherein in the electronic control unit a nominal position of the at least signal transducer for a predetermined position of the piston and for a predetermined movement direction of the piston in the cylinder is stored and wherein an actual position of the at least one signal transducer in the predetermined position of the piston and in the predetermined movement direction of the piston in the cylinder deviates by less than 2.5° crank angle from the nominal position.

10. The hand-guided power tool according to claim 1, wherein the polygonal conical section of the crankshaft comprises a circumferential surface, wherein the circumferential surface, in a plane in which the axis of rotation of the crankshaft is located, is positioned at an angle of 6° to 12° relative to the axis of rotation of the crankshaft.

11. The hand-guided power tool according to claim 1, wherein the polygonal conical section of the crankshaft comprises at least three sidelines, wherein points are located on the sidelines and said points, in section planes perpendicular to the axis of rotation of the crankshaft, have a greatest spacing of a circumferential surface of the polygonal conical section in the section planes relative to the axis of rotation of the crankshaft.

12. The hand-guided power tool according to claim 11, further comprising a magnet ring arranged on the support, wherein the at least one signal transducer is fixed on the magnet ring, and wherein the support comprises positioning means configured to position the magnetic ring on the support relative to one of the sidelines of the polygonal conical section.

13. The hand-guided power tool according to claim 1, wherein a plurality of the at least one signal transducer are fixed at regular spacings relative to each other on a circle about the axis of rotation on the support.

14. The hand-guided power tool according to claim 1, wherein the support is a flywheel.

15. The hand-guided power tool according to claim 1, wherein the support is a fan wheel comprising air guiding elements arranged on a side of the fan wheel facing away from the cylinder.

16. The hand-guided power tool according to claim 1, wherein the at least one signal transducer is a magnet inducing a voltage signal in a coil upon rotation of the support, wherein the voltage signal is the signal generated by the at least one signal transducer.

17. The hand-guided power tool according to claim 1, comprising a pressure sensor arranged on a crankcase of the internal combustion engine and configured to measure a pressure in the crankcase, wherein the pressure sensor measures at least at a certain point in time the pressure in the crankcase and the point in time of measuring the pressure in the crankcase is determined by the electronic control unit as a function of the signal.

18. A method for producing a hand-guided power tool comprising an internal combustion engine comprising a cylinder and a piston, disposed in the cylinder and delimiting together with the cylinder a combustion chamber, and further comprising a crankshaft and a connecting rod connecting the piston and the crankshaft, wherein the piston in operation of the internal combustion engine rotatably drives the crankshaft about an axis of rotation of the crankshaft; an electronic control unit; an ignition device comprising a spark plug; a support fixedly connected to the crankshaft; at least one signal transducer fixedly connected to the support; wherein the ignition device, utilizing a signal generated by the at least one signal transducer, fires the spark plug at a timing which is predetermined by the electronic control unit; wherein the support comprises a polygonal conical receptacle; wherein the crankshaft comprises a polygonal conical section corresponding with the polygonal conical receptacle of the support and arranged in the polygonal conical receptacle of the support to fixedly connect the support and the crankshaft to each other; the method comprising:
providing the crankshaft with an alignment element;
grinding the polygonal conical section of the crankshaft such that the polygonal conical section is oriented in a predefined way relative to the alignment element.

19. The method according to claim 18, further comprising:
casting the support in a casting mold comprised of a plurality of casting mold parts and forming the polygonal conical receptacle of the support and positioning means provided on the support, the positioning means configured to position a magnetic ring on the support relative to the polygonal conical section, by the same casting mold part of the casting mold.
